(19) United States
(12) Patent Application Publication
(10) Pub. No.: US 2026/0352111 A1
(43) Pub. Date: Nov. 5, 2026

(54) HIGH-EFFICIENCY BI-DIRECTIONAL SINGLE-STAGE SERIES RESONANT CONVERTER

(71) Applicant: Atieva, Inc., Newark, CA (US)

(72) Inventors: Shantanu Gupta, Newark, CA (US); Yucheng Gao, Newark, CA (US); Dung Anh Nguyen, Newark, CA (US); Seyed Amir Assadi, Newark, CA (US); Shan Chai, Newark, CA (US); Xiaoyi Yang, Newark, CA (US)

(21) Appl. No.: 19/195,497

(22) Filed: Apr. 30, 2025

(51) Int. Cl. H02M 3/335; B60L 53/16; B60L 53/22; H02M 1/00; H02M 3/00

(52) U.S. Cl. CPC H02M 3/33573; B60L 53/22; H02M 1/0058; H02M 3/01; H02M 3/33584; B60L 53/16

(57) ABSTRACT

An electric vehicle may comprise a bidirectional converter with a resonant circuit coupling a first full-bridge circuit and a second full-bridge circuit together. A controller is configured to operate all the switches of the first full-bridge circuit and the second full-bridge circuit in zero volt switching (ZVS) mode, by determining phase shift parameters d1, d2, and d3, in accordance with at least the ZVS boundary condition of at least a first subset of switches of the first full-bridge circuit and the second full-bridge circuit.

### FIELD

Embodiments disclosed relate generally to power electronics, and more particularly, to an enhanced bidirectional converter with resonant circuit and control modulation based on the resonant circuit, in accordance with an embodiment.

### BACKGROUND

An electric vehicle typically include one or more motors that convert energy stored in an onboard battery pack to mechanical energy, in the form of a rotational movement. As electric vehicle technologies advance, so do their capabilities. With new advancements, EVs may operate an onboard battery pack under several modes of operation, including grid-to-vehicle (G2V), vehicle-to-grid (V2G), vehicle-to-home (V2H), and vehicle-to-load (V2L) systems. Such operation may be governed by an integrated control system that manages power flow direction to and from the vehicle battery. The control system typically includes power electronic devices (e.g., semiconductors designed for high current applications) that control the flow of electric current to and from the battery pack. One such system may be referred to as a bidirectional converter. It is desirable to operate such a system in an energy efficient manner, while considering various tradeoffs between performance, efficiency, cost, and more.

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

Aspects of the present disclosure relate to an electric vehicle with a bidirectional converter. The bidirectional converter comprises a first full-bridge circuit comprising a first half-bridge pair of switches (S1, S3) and a second half-bridge pair of switches (S2, S4); a second full-bridge circuit comprising a third half-bridge pair (S5, S7) of switches and fourth half-bridge pair of switches (S6, S8); a resonant circuit comprising a first inductor connected in series with a first capacitor, wherein the resonant circuit electrically couples the first full-bridge circuit and the second full-bridge circuit; and a controller that is configured to operate the bidirectional converter. Each switch may comprise one or more power switching devices such as a metal-oxide semiconductor field-effect transistor (MOSFET) or other suitable power switching device.

The controller is configured to determine a first duty cycle phase shift (d₁) associated with the second half-bridge pair relative to the first half-bridge pair; determine a second duty cycle phase shift (d₂) associated with the fourth half-bridge pair relative to the third half-bridge pair; determine a third duty cycle phase shift (d₃) associated with the third half-bridge pair relative to the first half-bridge pair, based on a zero volt switching (ZVS) boundary condition of a first switch (S5) of the third half-bridge pair, and of a first switch (S6) of the fourth half-bridge pair. The ZVS boundary condition of the S5 and the S6 comprises at least: an impedance (Z₀) of the resonant circuit, a resonant frequency (ω₀) of the resonant circuit, a ZVS current (I_{z}) associated with the S5 and the S6, a period (Tₛ) associated with a switching frequency of the first full-bridge circuit and the second full-bridge circuit, and a gain (G) that is associated with a first voltage (v₁) of the first full-bridge circuit and a second voltage (v₂) of the second full-bridge circuit. The controller is configured to drive each of the first half-bridge pair, the second half-bridge pair, the third half-bridge pair, and the fourth half-bridge pair, with a corresponding pulse width modulation (PWM) signal at the switching frequency, generated based on the d₁, the d₂, and the d₃.

In some embodiments, determining the d₁ comprises setting d₁ to zero, and determining the d₂ comprises setting d₂ to zero. With d₁ and d₂ set to zero, d₃ can be determined in a straightforward manner. In some embodiments, d₃ is determined based on a modeled expression comprising:

$${d}_{3} = 0.25 - \frac{{sin}^{- 1} ( - \frac{{I}_{z} {Z}_{0}}{{v}_{1}} cos ( \frac{{ω}_{0} {T}_{S}}{4} ) + G sin ( \frac{{ω}_{0} {T}_{S}}{4} ) )}{{ω}_{0} {T}_{S}}$$

when G is less than 1, and

$${d}_{3} = 0.25 - \frac{{sin}^{- 1} ( - \frac{{I}_{z} {Z}_{0}}{{v}_{1}} cos ( \frac{{ω}_{0} {T}_{S}}{4} ) + \frac{1}{G} sin ( \frac{{ω}_{0} {T}_{S}}{4} ) )}{{ω}_{0} {T}_{S}}$$

when G is greater than or equal to 1.

In some embodiments, determining d₃ comprises inverting the gain G, in response to G being above a threshold, as shown in the model above.

In some embodiments, in response an instantaneous power and the gain G exceeding a boundary of the switching frequency at a maximum load of the bidirectional converter, the controller fixes the switching frequency to a constant value (e.g., at fₘₐₓ or fₘᵢₙ, depending on which boundary is exceeded). The controller continues to control the bidirectional inverter by adjusting d₃. This mode with the fixed switching frequency may be referred to as phase shift mode (PSM).

In some embodiments, determining the d₂ comprises setting the d₂ at zero. With d₂ at zero, the controller determines the d₁ and the d₃ are based on the ZVS boundary condition of the S5 (and S7) and the S6 (and S8) and further based on a ZVS boundary condition of a first switch (S2 and S4) of the second half-bridge pair. The ZVS boundary condition of the S2 (and S4) comprises at least: Z₀, ω₀, I_{z} associated with the S2, and Tₛ.

In some embodiments, phase shifts d₁, d₃, and targeted power P₀ are determined based on the following model:

$$- {I}_{Z} = - \frac{{v}_{1} ( sin ( {w}_{0} {T}_{S} ( 0.25 - {d}_{1} ) ) + sin ( \frac{{w}_{0} {T}_{S}}{4} ) - 2 G sin ( {w}_{0} {T}_{S} ( \frac{1}{4} + {d}_{1} - {d}_{3} ) ) )}{2 {Z}_{0} cos ( \frac{{w}_{0} {T}_{S}}{4} )} ,$$

$${I}_{Z} = - \frac{{v}_{1} ( sin ( {w}_{0} {T}_{S} ( 0.25 - {d}_{1} ) ) + sin ( {w}_{0} {T}_{S} ( 0.25 - {d}_{3} + {d}_{1} ) ) - 2 G sin ( \frac{{w}_{0} {T}_{S}}{4} ) )}{2 {Z}_{0} cos ( \frac{{w}_{0} {T}_{S}}{4} )} , and$$

$${P}_{o} = \frac{2 {Gv}_{1}^{2}}{{w}_{0} {T}_{S} {Z}_{0}} ( \frac{( cos ( \frac{{w}_{0} {T}_{S}}{4} ( 4 {d}_{1} - 4 {d}_{3} + 1 ) ) + cos ( \frac{{w}_{0} {T}_{S}}{4} ( 4 {d}_{3} - 1 ) ) )}{cos ( \frac{{w}_{0} {T}_{S}}{4} )} - 2 ) .$$

In some embodiments, d₁, d₃, and targeted power P₀ are determined based on using a lookup table. Inputs to the lookup table may include G, Tₛ, ω₀, I_{z}, and/or other parameters. The lookup table may relate the inputs to an output value of d₁, d₃, and P₀, according to the model above.

In some embodiments, the first full-bridge circuit is coupled to an unfolding bridge circuit, to support an AC voltage input at the first full-bridge circuit.

In some embodiments, each switch of the first half-bridge pair and the second half-bridge pair of the first full-bridge circuit comprises two power switching devices coupled in series. These back-to-back switches may each comprise a diode arranged across the respective drain-source of the switch, and in opposite directions relative to each other. The first full-bridge circuit is coupled to an alternating current (AC) voltage.

In some embodiments, the bidirectional converter directs energy between an EV battery and an external power source. For example, the second full-bridge circuit can be coupled to the battery of the electric vehicle, and the first full-bridge circuit can be coupled to a vehicle port of the EV. The vehicle port may receive a connector (e.g., a plug) that is coupled to the external power source (e.g., a battery charger, a grid, another battery, another vehicle, etc.).

In some embodiments, the resonant circuit comprises a second inductor coupled in series to a second capacitor, and a transformer that couples the first inductor and the first capacitor to the second inductor and the second capacitor. In this configuration, the first full bridge and the second full bridge are galvanically isolated from each other.

In an aspect, a method is disclosed that is performed by a processing device, such as a controller of an electric vehicle. In an aspect, a non-transitory computer readable memory stores machine executable instructions that, when executed by a processing device, causes the operations of the method to be performed. In an aspect, the bidirectional converter is operative in a system that is unrelated to or external to an electric vehicle.

Other technical features may be readily apparent to one skilled in the art from the following figures, descriptions, and claims.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 illustrates an example of a bidirectional converter, in accordance with some embodiments.

FIG. 2 shows waveforms of a bidirectional converter for a given frequency ratio, in accordance with some embodiments.

FIG. 3 shows examples of the bidirectional converter, in accordance with some embodiments.

FIG. 4. showcases an example of the contour plot associated with output power, inductor current, and a ZVS boundary condition of the bidirectional converter, in accordance with some embodiments.

FIG. 5 shows operation of a bidirectional converter operating based on a ZVS boundary condition (e.g., point 1), in accordance with some embodiments.

FIG. 6 show graphs of signals of a bidirectional converter for DC/AC operation under various conditions, in accordance with some embodiments.

FIG. 7 shows the graph indicating control parameter dependency for operation based on a ZVS boundary condition (e.g., point 2), in accordance with some embodiments.

FIG. 8 shows an example electric vehicle with enhanced bidirectional converter operation, in accordance with some embodiments.

FIG. 9 shows a comparison of a bidirectional converter operating under a first ZVS boundary condition (e.g., point 1) and under a second ZVS boundary condition (e.g., point 2), in accordance with some embodiments.

FIG. 10 shows example waveforms of a bidirectional inverter operating under a first ZVS boundary condition (e.g., point 1) and under a second ZVS boundary condition (e.g., point 2), in accordance with some embodiments.

FIG. 11 shows a flow diagram of a method for operating a bidirectional converter, according to some embodiments.

FIG. 12 is a high-level view of some embodiments of a vehicle, in accordance with some embodiments.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “transmitting”, “storing”, “determining”, “accessing”, “referencing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

A single-stage bidirectional converter with a resonant circuit is disclosed. Such a bidirectional converter can enhance DC/AC and AC/DC conversion, by reducing conduction and switching losses that are typical within typical bidirectional converters. The bidirectional converter can support loads that draw large inrush current for short duration of time, as is typical of loads such as motors and transformers. The impedance of the resonant circuit has non-linear dependency on the switching frequency which provides an additional effective control parameter. Based on this non-linear dependency and additional control parameter, the bidirectional converter can support increased power for short time duration than the rated power of components of the bidirectional converter, by varying switching frequency. This ability to support large bursts of power make the bidirectional converter ideal for loads which command high inrush current.

In an embodiment, a bidirectional converter comprises a first full-bridge circuit comprising a first half-bridge pair of switches and a second half-bridge pair of switches; a second full-bridge circuit comprising a third half-bridge pair of switches and fourth half-bridge pair of switches; a resonant circuit comprising a first inductor connected in series with a first capacitor, where the resonant circuit electrically couples the first full-bridge circuit and the second full-bridge circuit; and a controller, configured to operate the bidirectional converter. The controller is configured to determine a first duty cycle phase shift (d₁) associated with the second half-bridge pair relative to the first half-bridge pair; determine a second duty cycle phase shift (d₂) associated with the fourth half-bridge pair relative to the third half-bridge pair; determine a third duty cycle phase shift (d₃) associated with the third half-bridge pair relative to the first half-bridge pair, based on a zero volt switching (ZVS) boundary condition of a first switch (S5) of the third half-bridge pair, and of a first switch (S6) of the fourth half-bridge pair. The ZVS boundary condition of the S5 and the S6 comprises at least: an impedance (Z₀) of the resonant circuit, a resonant frequency (ω₀) of the resonant circuit, a ZVS current (I_{z}) associated with the S5 and the S6, a period (Tₛ) associated with a switching frequency of the first full-bridge circuit and the second full-bridge circuit, and a gain (G) that is associated with a first voltage (v1) of the first full-bridge circuit and a second voltage (v2) of the second full-bridge circuit. The controller is configured to drive each of the first half-bridge pair, the second half-bridge pair, the third half-bridge pair, and the fourth half-bridge pair, with a corresponding pulse width modulation (PWM) signal at the switching frequency, generated based on phase shifts d₁, d₂, and d₃. In some embodiments, the same Iz of the ZVS boundary condition is applied for the other switches as well, including complementary switches in a pair, such as, for example, S1/S3, S2/S4 pair, S5/S7, and S6/S8. As such, the ZVS boundary condition of Iz applies to both switches in a complementary switch pair. In some embodiments, some switches are turning on with −Iz drain-to-source current.

The controller applies a model of the bidirectional converter to accurately determine the control parameters of the bidirectional converter or rapid parameter and modulation of the converter. The controller may utilize a linearization function based on the developed model to simplify the control. The controller can determine and apply a modulation scheme which relates four control parameters (switching period (Ts) and three phase-shift variables (d₁, d₂, d₃,)) offering minimization of conduction loss while ensuring ZVS turn-on of all the switches for wide operating condition. In some embodiments, the controller may operate (e.g., turn on) the switches of the bidirectional converter in complete zero voltage switching (ZVS) operation, which increases the switching frequency of the bidirectional converter, reduces switching loss, and reduces the size and cost of the passive components.

The bidirectional converter supports high Lock Rotor Ampere (LRA) while using a smaller switching frequency change compared to other conventional single-stage solutions (e.g., a dual active bridge (DAB) converter in V2H or V2L). A high drop in switching frequency significantly increases transformer core loss and ripple on the AC side capacitor, thereby limiting the DAB converter in LRA applications. Unlike the DAB converter, the disclosed bidirectional converter has a non-linear dependency of maximum output power on the switching frequency which makes the bidirectional converter more suitable for nominal operation as well as during bursts of inrush current such as in LRA applications. The disclosed bidirectional converter can optimize the modulation (e.g., on-off pattern) of the switches based on the hardware characteristics. When turn-off losses are more severe compared to conduction loss (such as, for example, during low load condition), the bidirectional converter can mitigate turn-off losses at the expense of higher conduction loss.

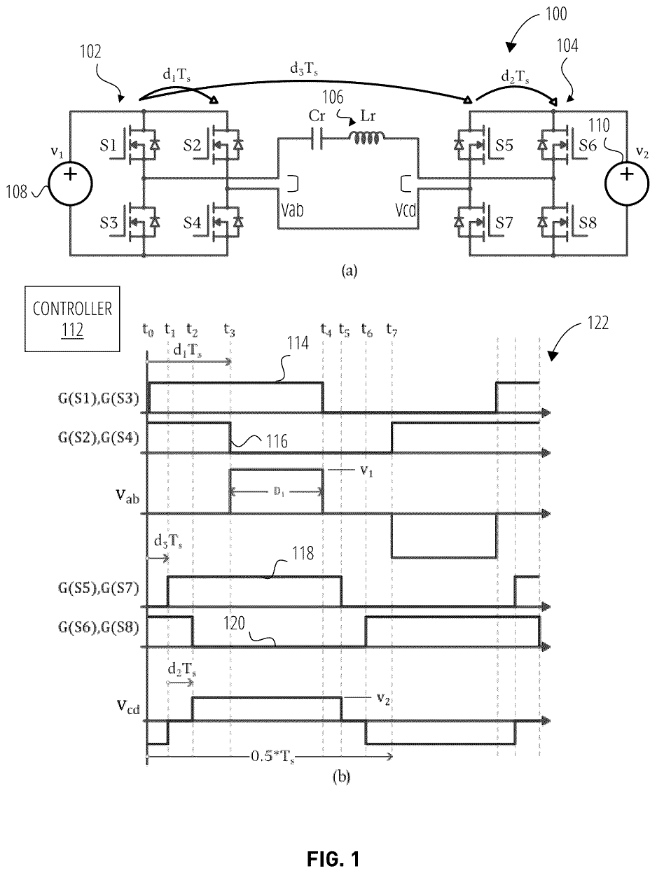

FIG. 1 illustrates an example of a bidirectional converter 100, in accordance with some embodiments. Bidirectional converter 100 comprises a first full bridge circuit 102, a second full bridge circuit 104, and a resonant circuit 106.

The first full bridge circuit 102 comprises a first half-bridge pair of switches (S1, S3) and a second half-bridge pair of switches (S2, S4). The second full-bridge circuit 104 comprises a third half-bridge pair of switches (S5, S7) and a fourth half-bridge pair of switches (S6, S8). The pair of switches in each half-bridge are connected in series as shown.

The resonant circuit 106 comprises a first inductor (Lr) and a first capacitor (Cr). The resonant circuit 106 electrically couples the first full bridge circuit 102 and the second full-bridge circuit 104. For example, a connection between S1 and S2 is coupled to a first end Cr. The second end of Cr is connected to a first end of Lr. The second end of L, is connected to a connection between S6 and S8 of the fourth half-bridge pair.

A controller 112 is configured to generate control signals to drive the switches of the first full bridge circuit 102 and the second full bridge circuit 104 to move current from first voltage (v1) 108, and second voltage (v2) 110. The controller 112 modulates the first full bridge circuit 102 and second full bridge circuit 104 to act as a single stage converter. A single-stage converter performs a specific energy conversion (e.g., v1 to v2, or v2 to v1), in a single step, rather than requiring multiple stages in more traditional converters.

First voltage v1 may comprise an alternating current (AC) source or direct current (DC) source. The second voltage v2 may comprise a DC source such as, for example, a battery of an electric vehicle.

The controller 112 may comprise one or more processing devices such as, for example, a digital signal processor (DSP), a general microprocessor, programmable logic such as, for example, a complex programmable logic device (CPLD) or field programmable gate array (FPGA), or other programmable logic device, or any combination of such processing devices. The controller 112 may comprise one or more inputs configured to receive various sensed parameters associated with the bidirectional converter 100 such as, for example, currents and/or voltages at first voltage 108, second voltage 110, and/or resonant circuit 106.

The controller is configured to generate, as output, control signals such as pulse width modulated (PWM) signals which control each of the half bridge pairs, respectively. The controller 112 may generate four PWM signals simultaneously. First PWM signal 114 is generated and applied to control the first half-bridge pair (S1, S3), second PWM signal 116 is generated and applied to control the second half-bridge pair (S2, S4), third PWM signal 118 is generated and applied to the third half-bridge pair (S5, S7), and fourth PWM signal 120 is generated and applied to the fourth half-bridge pair (S6, S8).

The duty cycle of each of the PWMs may vary according to a pre-defined modulation table. The parameters that the controller 112 changes dynamically are the phase shift of each of the PWMs and the switching frequency fₛ or switching period Tₛ. It should be understood that fₛ and Tₛ may be derived from one another and may be used interchangeably. The phase shift parameter d₁ represents a phase shift (e.g., a difference in phase) between the first PWM signal 114 and the second PWM signal 116. Similarly, phase shift parameter d₃ represents a phase shift between the first PWM signal 114 and the third PWM signal 118, and d₂ represents a phase shift between the third PWM signal 118 and the fourth PWM signal 120. Tₛ is the period of the switching frequency fₛ, which the controller 112 may determine and change dynamically based on load conditions. Generally, the controller 112 is configured to operate all the switches of the first full-bridge circuit and the second full-bridge circuit in zero volt switching (ZVS) mode, by determining the phase shift parameters d₁, d₂, and d₃, in accordance with at least a ZVS boundary condition of at least a first subset of switches (e.g., S5 and S6) of the first full-bridge circuit and the second full-bridge circuit. In some embodiments, in addition to the ZVS boundary condition of the first subset of switches, the controller 112 determines d₁, d₂, and d₃ in accordance with a second ZVS boundary condition of a second subset of switches (e.g., S2). A ZVS boundary condition refers to the d₁, d₂, and d₃ values that operate the respective switches at the threshold of zero volt switching. At this boundary and threshold, a greater or smaller phase shift will result in non ZVS operation. By operating in these ZVS boundary conditions of the select subset of switches, all switching devices of the bidirectional converter 100 are operated under ZVS, thereby reducing switching losses.

As shown in the graph 122, the second PWM signal 116 may be determined as a copy of first PWM signal 114 but phase shifted by d₁Tₛ and inverted. Similarly, third PWM signal 118 is a copy of first PWM signal 114, but phase shifted by d₃Tₛ. Similarly, fourth PWM signal 120 is an inverse copy of third PWM signal 118, but phase shifted by d₂Tₛ.

The controller 112 may determine the first duty cycle phase shift (d₁), the second duty cycle phase shift (d₂), and the third duty cycle phase shift (d₃). In particular, the controller may determine d₃ based on a zero volt switching (ZVS) boundary condition of a first switch (S5) of the third half-bridge pair, and of a first switch (S6) of the fourth half-bridge pair. The ZVS boundary condition of the S5 and the S6 comprises at least: an impedance (Z₀) of the resonant circuit 106, a resonant frequency (ω₀) of the resonant circuit 106, a ZVS current (I_{z}) associated with the S5 and the S6, the period (Tₛ) associated with the switching frequency of the first full-bridge circuit and the second full-bridge circuit, and a gain (G) that is associated with first voltage 108 of the first full-bridge circuit and the second voltage 110 of the second full-bridge circuit.

Controller 112 drives each of the first half-bridge pair, the second half-bridge pair, the third half-bridge pair, and the fourth half-bridge pair, with a corresponding pulse width modulation (PWM) signal at the switching frequency, generated based on the d₁, the d₂, and the d₃. For example, first half-bridge pair is driven with first PWM signal 114. Second half-bridge pair (S2, S4) is driven with second PWM signal 116 which is determined from the phase shift d₁ and the switching frequency period Tₛ. Third half-bridge pair (S5, S7) is driven with third PWM signal 118 which is determined from the phase shift d₃ and the switching period Tₛ. Fourth bridge pair (S6, S8) is driven with fourth PWM signal 120 which is determined from the phase shift d₂ and Tₛ. Given that the duty cycle of first PWM signal 114 starts at the switching frequency period Tₛ, controller 112 may control all four signals based on controlling d₁, d₂, d₃, and Tₛ.

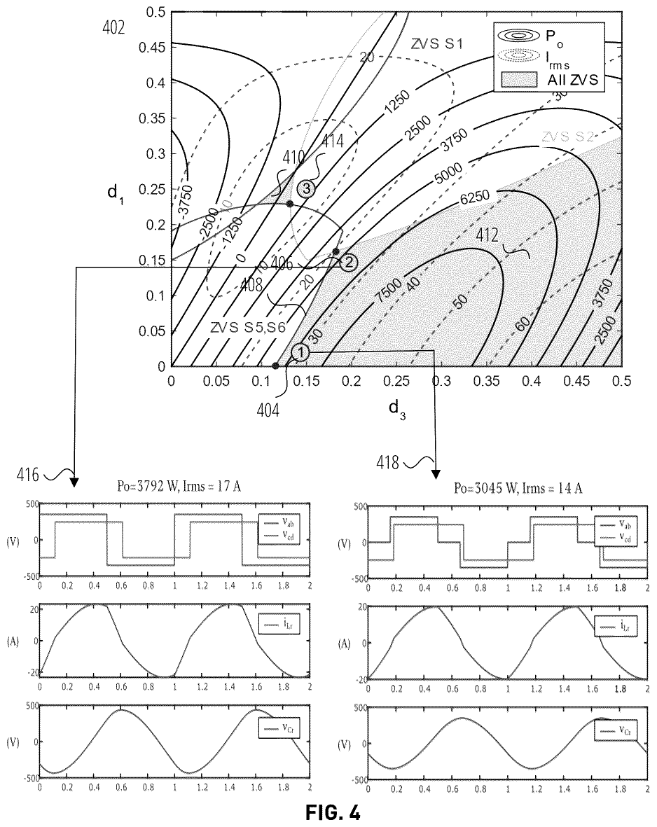

In some embodiments, controller 112 determines d₁, d₂, d₃ in view of ZVS boundary conditions of S5, S6 and S2. In some embodiments, d₂ is set to zero, while determining d₁ and/or d₃. Controller 112 may fix d₂ at zero to reduce the number of changing variables, so that controller 112 may solve for d₁ and d₃ within the ZVS boundary conditions of S5, S6 and/or S2. An example of such control is shown in the contour plot 402 of FIG. 4. The controller 112 may operate the bidirectional converter 100 to operate at the ZVS boundary condition 404, which is associated with maintaining ZVS current of S5 and S6 while d₁ and d₂ is set to zero, or at ZVS boundary condition 406, which is associated with maintaining ZVS boundary conditions of S2, or ZVS boundary condition 408, which is bound by the ZVS boundary conditions of S5, S6 under a non-zero d₁. The ZVS boundary condition represents the threshold at which the switching devices operate under ZVS conditions, so by solving for D1 and D2 in view of these boundary conditions, which account for non-linear behavior of the resonant circuit 106, controller 112 and bidirectional converter 100 operate with improved efficiency during nominal conditions and improved range during demand spikes (e.g., inrush current).

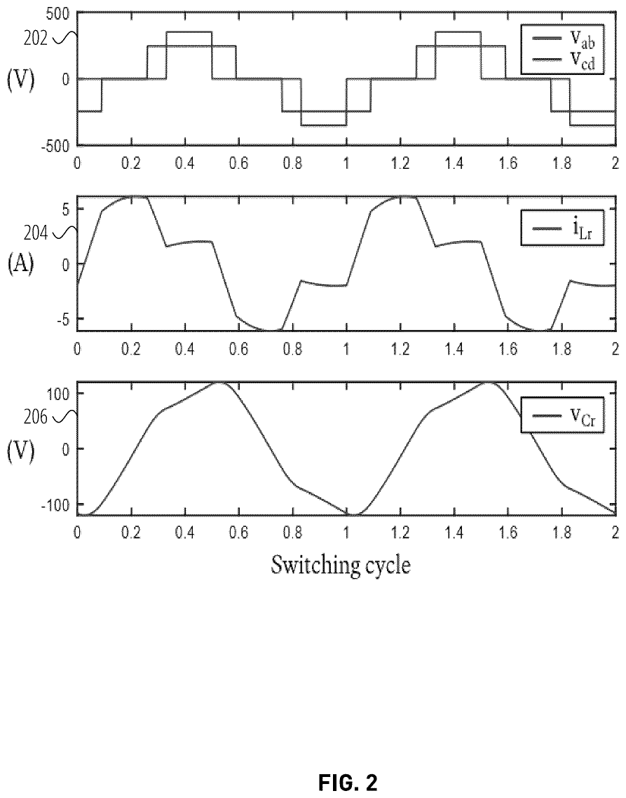

It should be understood that FIG. 1 shows a simplified diagram of a bidirectional converter 100. For example, other embodiments of a first full bridge circuit 102 are shown in other sections, as are other embodiments of the resonant circuit 106. The resonant frequency f₀ is related to switching frequency, fₛ by fᵣ=f₀/fₛ. The presence of the resonant link (Cᵣ in series with the Lᵣ) results in non-linear inductor current, i_{Lr} as shown in FIG. 2 below, as fᵣ increases toward unity.

FIG. 2 shows waveforms of a bidirectional converter 100 for a given frequency ratio, in accordance with some embodiments. In this example, the frequency ratio fᵣ given by the ratio of f₀/fₛ=0.85. The graph 202 shows Vab and Vcd during a complete switching period (e.g., a switching period Tₛ). Graph 204 shows the current through inductor Lr of the resonant circuit 106 during the complete switching period. Graph 206 shows the voltage across capacitor Cr of the resonant circuit 106 during the complete switching period. As graphs 204 and 206 show, the resonant circuit 106 adds non-linear current and voltage response to the system. The bidirectional converter 100 uses the non-linearity provided by the resonant circuit 106 to extend the limited ZVS region compared with traditional single stage solutions, to achieve improved sensitivity on power transfer capability of the bidirectional converter 100 with variable switching frequency. This enhancement offers better performance of the bidirectional AC/DC or DC/AC converter over wide battery voltage and power ranges.

To capture the effect of the non-linearity of the converter, each half-bridge pair S1-S3, S2-S4, S5-S7 and S6-S8 may be considered separately to solve the resultant inductor current I_{LR}. Accurate modeling of the bidirectional converter 100 is important to design the bidirectional converter 100 and formulate a modulation scheme that allows optimized operation of the bidirectional converter 100. The conduction loss of the bidirectional converter 100 are dependent on the circulating current through the components. The switching loss of the switches of the bidirectional converter 100 are dependent on the current and voltage across the switching when switch commutates. The conduction loss and the switching loss together form the major portion of the overall loss of bidirectional converter 100. Multiple set of control parameters can offer the same desired output power but with different conduction and switching losses. Hence, bidirectional converter 100 implements a modulation scheme can with an optimal solution that is tailored to a desired operating condition.

The zero-voltage switching (ZVS) turn-on of each switch of bidirectional converter 100 requires negative drain-to-source current, i_{ds} to discharge the output capacitance of the switch (Cₒₛₛ) before gate signal is applied. As i_{ds} take finite time to discharge the capacitance, a desired value of i_{ds} is required to obtain ZVS-turn on. The required current ZVS current Iz can be expressed as

$${i}_{ds} < {I}_{s} = \frac{{C}_{OSZ} {v}_{ds}}{{t}_{db}} ,$$

where v_{ds} is the drain-to-source voltage across the switch under consideration, and t_{db} is the deadtime.

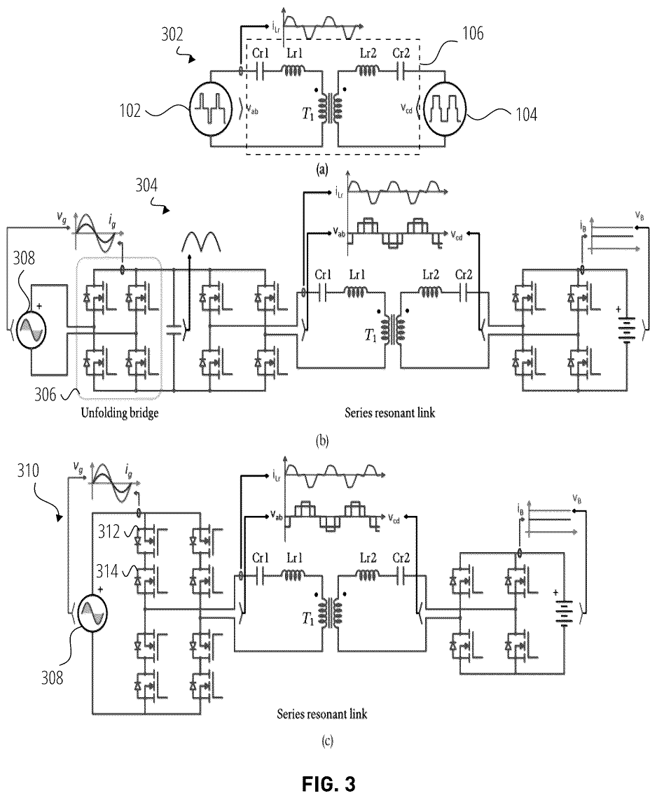

FIG. 3 shows examples of the bidirectional converter 100, in accordance with some embodiments.

In circuit 302, an embodiment of a bidirectional converter 100 is shown, which may include a resonant circuit 106 formed by a series connection of inductor and capacitor across two tri-state voltage sources Vab and Vcd. Block Vab may include first full bridge circuit 102, and block Vcd may include second full bridge circuit 104. The tri state voltage sources may enhance the operation of the converter. The resonant circuit 106 can comprise a first LC circuit (Cᵣ₁, Lᵣ₁) in series and coupled to a first winding of a transformer T₁, and a second LC circuit (Cᵣ₂, Lᵣ₂) in series and coupled to a second winding of T₁, however, the resonance of resonant circuit 106 can be simplified in terms of a single inductor and capacitor in series, as described with respect to FIG. 1. The use of multiple capacitors in the resonant circuit 106 offers protection against saturation of the of the transformer T₁, by dc-blocking. Further, relatively small physical size of these capacitors provide a sufficient and improved dynamic performance.

Circuit 304 shows an example of circuit 302, in accordance with an embodiment. The tri-state voltage source Vab of circuit 302 can be implemented using the first full bridge circuit shown (also referred to as an H bridge). As the MOSFET switches in the first full bridge can only block voltage in one direction in the direction of its respective MOSFET diode, circuit 304 is coupled to an unfolding bridge 306 to support an AC voltage source 308.

Circuit 310 shows another example embodiment of circuit 302, where the Vab block is implemented using a back-to-back MOSFET configuration. In this case, each switch of each pair comprises two MOSFETs. For example, switch 312 and switch 314 combine to form S1 of FIG. 1, and are so on. Each of these switches (e.g., switch 312, 314, and the other back-to-back switch pairs) include MOSFET diodes arranged across the drain source of the respective MOSFET and arranged in opposite directions relative to each other, to support the AC voltage source 308. The resonant circuit based-converter is also capable of performing dc/dc conversion as well, such as based on the general circuit of FIG. 1.

FIG. 4. showcases an example of the contour plot 402 associated with output power, inductor current, and ZVS boundary conditions of the bidirectional converter, in accordance with some embodiments.

The contour plot 402 shows circulating current (inductor RMS current), output power (Pₒ), and ZVS boundary conditions of the switches with respect to the different phase shifts of d₁ and d₃, while d₂ is fixed at zero. In this example, conditions for the bidirectional converter are fᵣ=0.77, v₁=350 V, v₂=245 V and Lᵣ=40 nH.

Given the constraints, 3 points of interest (shown as ‘1’, ‘2’, and ‘3’ in the circles) are observed in SR converter for a given switching frequency, resonant circuit design, and input and output voltages. The shaded regions 410 and 412 shows all switches are undergoing ZVS turn-on and hence have minimal switching losses. As the battery voltage is generally higher than the ac voltage, d₂ is maintained at 0 for simplification in developing modulation scheme. Point 1 (ZVS boundary condition 404) offers the simplest modulation scheme, as for this condition d₁=0. Point 2 (ZVS boundary condition 406) and Point 3 (ZVS boundary condition 414) offers low turn-off current on the MOSFET pairs S1-S4, S5-S8, and S6-S7 of I_{z}. These points also offer mean square circulating current per Watt delivered compared to point 1 (ZVS boundary condition 404).

Graphs 416 give the waveform for point 2 (ZVS boundary condition 406), while graphs 418 show waveforms for point 1 (ZVS boundary condition 404). Point 3 (ZVS boundary condition 414) is of lesser interest and is not shown. For each point, the effectiveness of the modulation can be measured by using the formula for cost given by the expression (1) below.

$$Cost = \frac{{I}_{rms}^{2}}{{P}_{o}} \qquad ( 1 )$$

From graphs 416 and 418, the cost of power delivery for point 1 is 76.2 A²/W whereas point 2 is associated with a power delivery cost of 64.4 A²/W.

In some embodiments, for the DC/AC application, the point 1 based modulation scheme is implemented by the controller 112. For point 1 based modulation, the controller 112 determines d3, based on the ZVS boundary condition 404. ZVS boundary conditions 404 may comprise at least the following parameters: an impedance (Z₀) of the resonant circuit 106, a resonant frequency (ω₀) of the resonant circuit 106, a ZVS current (I_{z}) associated with the S5 and the S6, the period (Tₛ) associated with the switching frequency of the first full-bridge circuit and the second full-bridge circuit, and a gain (G) that is associated with first voltage (v1) of the first full-bridge circuit and the second voltage (v2) of the second full-bridge circuit.

In some embodiments, a controller determines d3 by setting d2 to zero, and solving for d3 as given by

$${d}_{3 , VFM} = 0.25 - \frac{{sin}^{- 1} ( - \frac{{I}_{z} {Z}_{0}}{{v}_{1}} cos ( \frac{{ω}_{0} {T}_{S}}{4} ) + G sin ( \frac{{ω}_{0} {T}_{S}}{4} ) )}{{ω}_{0} {T}_{S}} ∀ G < 1 \qquad ( 2 a )$$

$${d}_{3 , VFM} = 0.25 - \frac{{sin}^{- 1} ( - \frac{{I}_{z} {Z}_{0}}{{v}_{1}} cos ( \frac{{ω}_{0} {T}_{S}}{4} ) + \frac{1}{G} sin ( \frac{{ω}_{0} {T}_{S}}{4} ) )}{{ω}_{0} {T}_{S}} ∀ G > 1 \qquad ( 2 b )$$

where ω₀=2πf₀ and G is the gain given by v₂/v₁. I_{z} is the negative drain to source current of a switch that drains the capacitance voltage of the switch to zero, and VFM indicates that the condition is associated with ‘variable frequency mode’, where the controller varies the switching frequency, unlike in phase shift mode (SPM), described below.

The model or equations above ensures operation at point 1, where turn-on current of MOSFET S5 and S6 is equal to −l_{z}, even with changing input voltage, output voltage, required power and changing the switching frequency.

The switching frequency fₛ or switching period (Tₛ) is dynamically controlled by the controller 112 to track a targeted output current. The switching frequency variation is bounded by the hardware capability for maximum switching frequency fₘₐₓ and the minimum switching frequency fₘᵢₙ is bounded by the switching frequency of the resonant circuit 106. The controller 112 may change modulation scheme to a constant switching frequency while only the phase shift d3 is used to maintain DC/AC conversion. The mode of operation where the switching frequency is controlled for the conversion and d3 is used to maintain the turn-on current to −I_{z} is referred as VFM, as mentioned above.

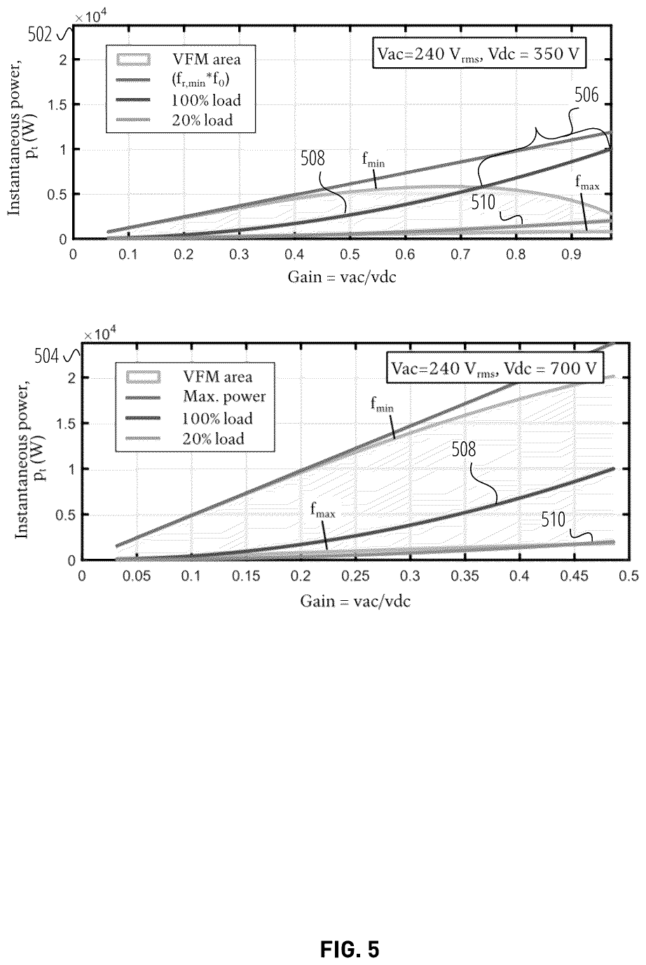

FIG. 5 shows operation of a bidirectional converter operating based on a ZVS boundary condition, in accordance with some embodiments. FIG. 5 shows graph 502, indicating the relationship between VFM operation, switching frequency and resonant frequency, and required power 508 and 510 under different loads (100% and 20%) at Vac=240 Vrms and Vdc=350 V. Graph 504 shows the same, but for Vdc at 700 V. Vdc may represent battery voltage, and therefore, the two graphs 502 and 504 may show operational characteristics of the bidirectional converter with different battery voltages. In particular, graphs 502 and 504 show a point 1 comparison for the designed converter (fₘᵢₙ=1.3f₀, fₘₐₓ=3.7% and f₀=108 kHz) at the two different input dc voltages of (a) Vdc=350 V, and (b) Vdc=700V. The shaded region bound by fₘᵢₙ and fₘₐₓ of both graphs 502 and 504 showcases the VFM operating regions.

For graph 502 (350 dc voltage case), the 100% load crosses out of the VFM mode with G>0.75 onward, resulting in fixed switching frequency, indicated by 506. As the required power 508 and gain falls outside the VFM region (indicated by 506), the controller 112 changes from VFM to PSM, where Ts is fixed to a constant value and only d₃ is varied to satisfy the desired output power and gain. The bidirectional converter can support up to 200% of the load at the maximum dc voltage. In an embodiment, when the controller transitions from VFM to PSM and/or vice versa, the controller performs a linearization function (f(x)=tanh(x)) to the output PWM that smoothens the transition between constant frequency and variable frequency mode.

Therefore, controller 112 may operate under VFM in response to when the required load and gain conditions are within the VFM operational area bound by fₘᵢₙ and fₘₐₓ. Under VFM operation, the controller 112 sets d₂ to zero and determines d₃ based on the ZVS boundary condition 404 as described. In response to the required load and gain falling out of the VFM operational area (e.g., under conditions 506), the controller 112 switches to a PSM operation and sets Tₛ to a constant, while still determining d₃ based on the ZVS boundary condition 404, as described.

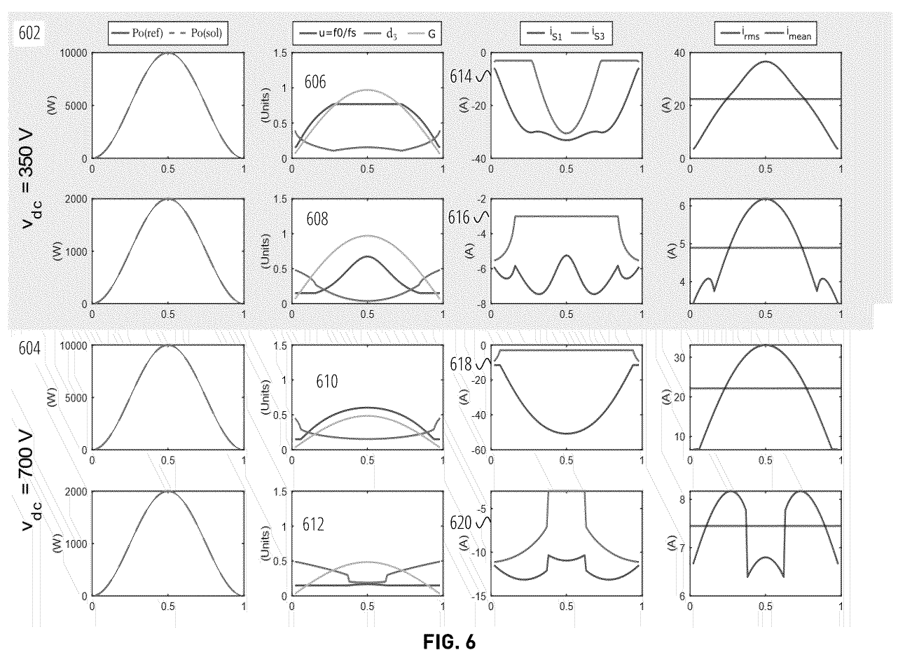

FIG. 6 show graphs of signals of a bidirectional converter for DC/AC operation under various conditions, in accordance with some embodiments. A first set of graphs 602 show operation of the bidirectional converter at Vdc at 350 V. The second set of graphs 604 show operation at Vdc at 700 V. Both sets of graphs show performance at high power or 100% load (0-1000 W) and at low power or 20% load (0-2000 W).

Graphs 606, 608, 610, and 612 show the relationship between the resonant frequency and switching frequency (f₀/fₛ) relative to d₃ and gain G at the different voltage and power levels. Graphs 614, 616, 618, and 620 indicate the current of switches S1 and S3 under each condition.

The graphs show the operating conditions for this case where |I_{z}|=3 A. The current at turn-on for S3 instance matches |I_{z}| while in the VFM mode, and results in increase in more current in negative direction at turn-on instance with increase in output power and gain. For the low load condition (20% load), the converter operates in PSM for low gain and low power due to saturation of the frequency to fₘₐₓ. For 700 V dc voltage, the SR converter is operating generally in VFM for full load condition. Under 20% load condition, the converter operates in PSM for the majority of the time while entering VFM for higher power and gain conditions. It can be seen based on the currents maintaining a negative bias (e.g., below −3 amps) that when the controller operates in VFM and PSM, each of the switches S1 and S3 (as well as all the other switches) are maintained in ZVS operation.

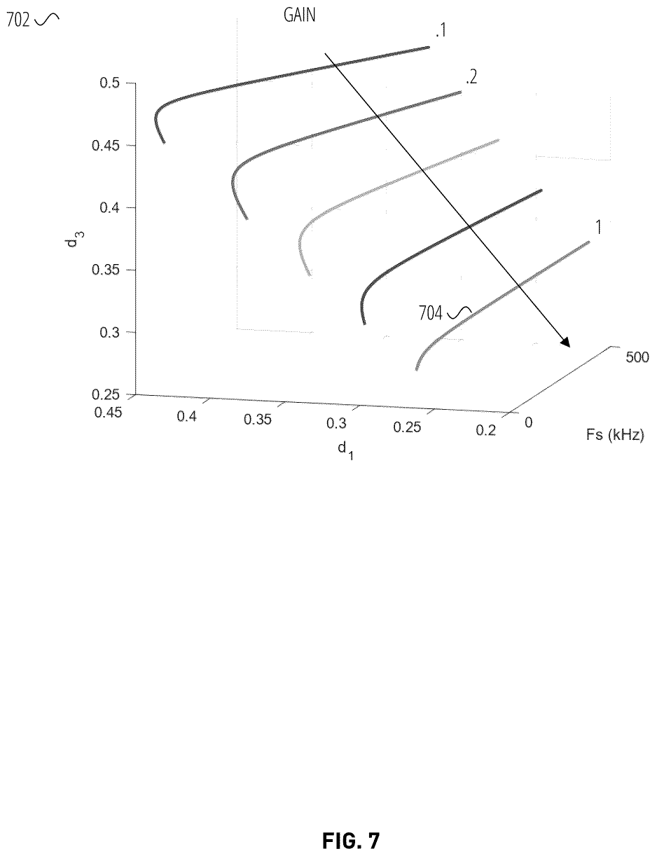

FIG. 7 shows the graph indicating control parameter dependency for operation based on a ZVS boundary condition (e.g., point 2), in accordance with some embodiments. In graph 702, the phase control parameters d₁ and d₃ are plotted with respect to switching frequency Fs. Controller 112 may fix d₂ to zero, as described, to solve for d₁ and d₃, based on the ZVS boundary condition 404 and ZVS boundary condition 406. As shown graph 702, different d1 and d3 phase shifts are determined, which may change according to switching frequency Fs.

Each of the lines show the relationship between d₁ and d₃ at different gains such as at 0.1 gain, 0.2 gain, to 1 (unity) gain which is shown as the last line 704.

In an embodiment, the controller 112 solves for d₁ and d₃ and also a targeted power P₀ based on the following modeled expressions.

$$- {I}_{Z} = - \frac{{v}_{1} ( sin ( {w}_{0} {T}_{S} ( 0.25 - {d}_{1} ) ) + sin ( \frac{{w}_{0} {T}_{S}}{4} ) - 2 G sin ( {w}_{0} {T}_{S} ( \frac{1}{4} + {d}_{1} - {d}_{3} ) ) )}{2 {Z}_{0} cos ( \frac{{w}_{0} {T}_{S}}{4} )} ,$$

$${I}_{Z} = - \frac{{v}_{1} ( sin ( {w}_{0} {T}_{S} ( 0.25 - {d}_{1} ) ) + sin ( {w}_{0} {T}_{S} ( 0.25 - {d}_{3} + {d}_{1} ) ) - 2 G sin ( \frac{{w}_{0} {T}_{S}}{4} ) )}{2 {Z}_{0} cos ( \frac{{w}_{0} {T}_{S}}{4} )} , and$$

$${P}_{o} = \frac{2 {Gv}_{1}^{2}}{{w}_{0} {T}_{S} {Z}_{0}} ( \frac{( cos ( \frac{{w}_{0} {T}_{S}}{4} ( 4 {d}_{1} - 4 {d}_{3} + 1 ) ) + cos ( \frac{{w}_{0} {T}_{S}}{4} ( 4 {d}_{3} - 1 ) ) )}{cos ( \frac{{w}_{0} {T}_{S}}{4} )} - 2 ) .$$

In some embodiments, the controller 112 may use a table (e.g., a lookup table) to solve for d₁ and d₃ and P₀ based on sensed and/or known parameters such as, for example, gain G, resonant circuit impedance I_{z}, and/or switching frequency period Ts. The table may reference the corresponding d₁ and d₃ based on the input parameters. The table may relate the phase shifts d₁ and d₃ to the input parameters based on the modeled expressions indicated above.

In such a manner, a controller 112 may determine the phase shift parameters d1 and d3 to operate the bidirectional converter 100 at point 2 (ZVS boundary condition 406).

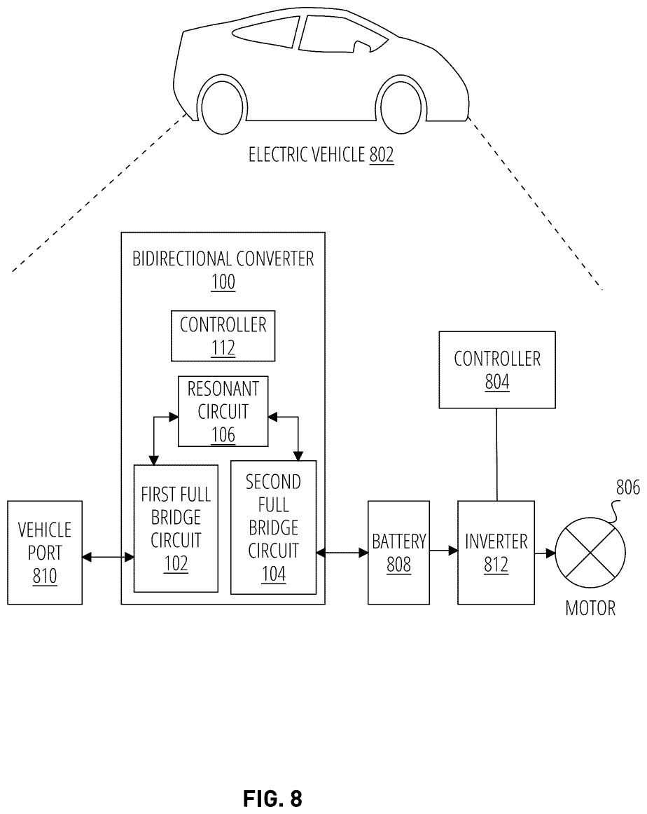

FIG. 8 shows an example electric vehicle with enhanced bidirectional converter operation, in accordance with some embodiments. Electric vehicle 802 may be an automobile having wheels coupled to a motor 806. Motor 806 may be a synchronous AC permanent magnet motor, an asynchronous AC motor, or other electric motor. In the case of an AC permanent magnet motor, motor 806 may comprise a rotor with permanent magnets that are embedded or attached to its surface. The motor 806 may comprise a stator, which is a stationary component of the motor 806. The stator may comprise windings that create a rotating magnetic field when AC current flows through them. The permanent magnets attached to the rotor are pulled into alignment with the rotating magnetic field of the stator, causing the rotor to rotate synchronously with the rotating magnetic field. The AC current may be supplied to the stator windings through an inverter 812 which may comprise a power electronics circuit comprising power semi-conductors such as, for example, MOSFETs, IGBTs, etc.) that are driven by control signals. The control signals may comprise pulse width modulated (PWM) signals that operate in a coordinated manner to control the inverter 812 to output a sinusoidal current or voltage to drive the motor 806 according to a desired torque and/or speed. Inverter 812 may be operated by controller 804. Controller 804 may be a single on board computing device, or distributed over a plurality of computing devices on the electric vehicle 802. The controller 804 may comprise processing logic such as, for example, a combination of electronic components, a computer processor, memory, and computer executable instructions stored on the memory) that performs a variety of different tasks associated with electric vehicle 802, such as controlling vehicle propulsion and steering through a series of control commands to vehicle actuators. Controller 804 may be configured to control motor 806 and other vehicle actuators and components such as, for example, a brake actuator, a steering actuator, electromechanical locks, window actuators, heating, etc.

The motor 806 and inverter 812 may receive stored energy from battery 808. Battery 808 may comprise a battery management system (BMS) that tracks state of charge (SOC), state of health (SOH), and measures battery parameters such as cell voltages, current, battery temperature, and/or cell temperatures.

The electric vehicle 802 comprises a bidirectional converter 100 that is coupled to the battery 808 and a vehicle port 810. Vehicle port 810 may comprise a receptacle that houses signal and power terminals, configured to mate with a plug with corresponding terminals. The plug may be coupled to an external energy source such as a utility grid having a standard AC voltage (e.g., 110 Vac, 220 Vac, 240 Vac, etc.). In another example, the plug may be coupled to an external DC source such as, for example, a DC fast charger, another vehicle, or other DC power source.

As described, bidirectional converter 100 comprises a first full bridge circuit 102 coupled to a second full bridge circuit 104 through resonant circuit 106. The controller 112 is configured to generate control signals (e.g., PWM signals) to drive first full bridge circuit 102 and second full bridge circuit 104 according to control parameters d₁, d₂, d₃, and Tₛ. As described with respect FIG. 4 and other sections, controller 112 may operate first full bridge circuit 102 and second full bridge circuit 104 in accordance with ZVS boundary condition 404, ZVS boundary condition 406, or ZVS boundary condition 408.

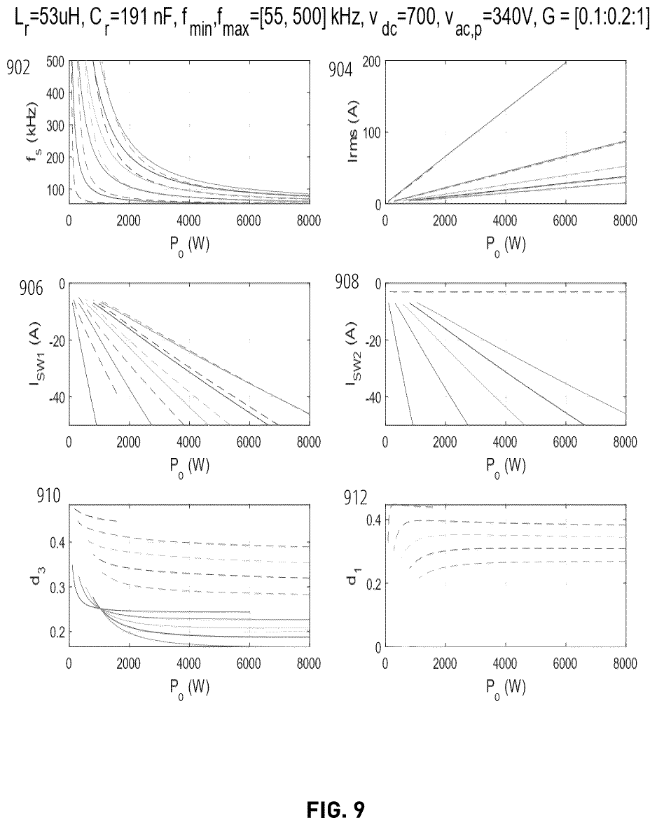

FIG. 9 shows a comparison of a bidirectional converter under point 1 operation and point 2 operation, in accordance with some embodiments. Point 1 refers to operating the bidirectional converter 100 according to ZVS boundary condition 404. Point 2 refers to operating the bidirectional converter 100 under ZVS boundary condition 406.

In this comparison, parameters of the bidirectional converter are Lr=53 uH, Cr−191 nF, fₘᵢₙ, fₘₐₓ=55,500 kHz, vdc=700v, vac=340 Vac. The different gain plots are plotted where the dashed lines are the grains for point 2 operation and the undashed lines represent the gains for point 1 operation.

Graph 902 shows relationship between a targeted operational power of the bidirectional converter and switching frequency fs with respect to each of the gains G. Based on the relationships, it is shown that point 2 operation has a greater range of switching frequency and the power.

Graph 904 shows the circulating current, Iᵣₘₛ through the inductor of the resonant circuit, which is shown to be the same for both point 1 and point 2 operation.

Graphs 906 and 908 show the ZVS current of the switches, and in particular, shows that control under both point 1 and point 2 achieve ZVS operation of all switches. Graph 908 further shows that for point 2 operation, the turn-off current is same as turn-on current of S2. Hence, the turn off stress on the switch is indicated to be lower.

Graphs 910 and 812 show the phase shift for d₃ and d₁ is greater for point 2 operation with respect to target operational power. The transformer core losses may be lower when operating under point 2 operation compared to point 1 operation. Point 2 may provide overall better performance relative to point 1 operation, but point 2 operation will require a more complicated solution function or a lookup table, which may potentially consume processing resources, memory resources, or be more complicated to develop, while point 1 provides a simpler calculation of phase control parameters while still achieving performance improvements over conventional bidirectional converters. It should be understood that rather than using a lookup table, other algorithms can be implemented to derive the parameters d1, d3, and P0.

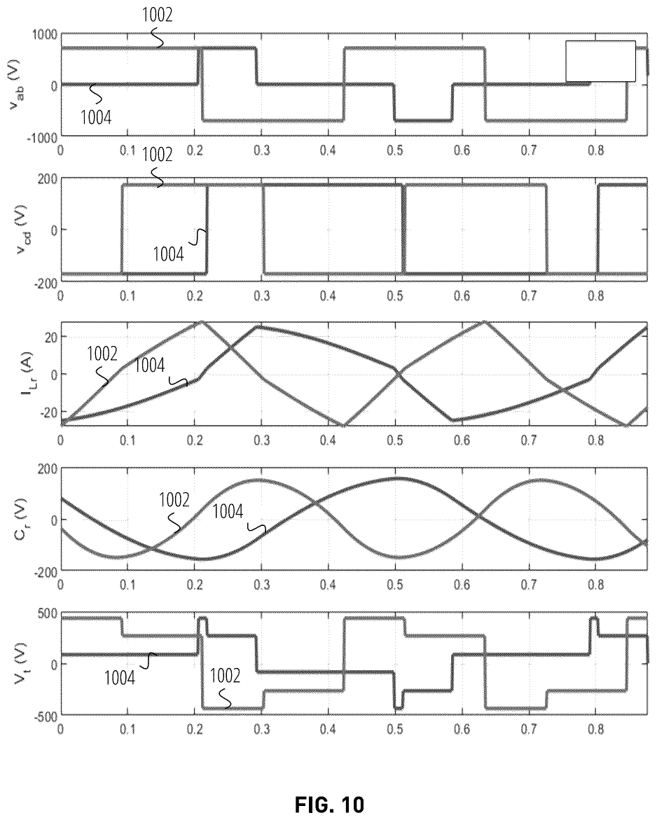

FIG. 10 shows example waveforms of a bidirectional inverter under point 1 operation and point 2 operation. In these graphs, the point 2 waveforms are determined based on a transformer voltage: 177 V, and switching fs of: 94 kHz, while the point 1 waveforms are determined based on transformer voltage of: 349 V, and switching frequency fs of: 130 kHz.

The waveforms 1002 are representative of point 1 operation, and the waveforms 1004 are representative of point 2 operation. It can be seen that the voltage waveform of Vab differs between the two points of operation, as does the current waveform through the resonant circuit inductor Lr and the voltage waveform across a transformer of the resonant circuit. Other waveforms also vary, but not as drastically.

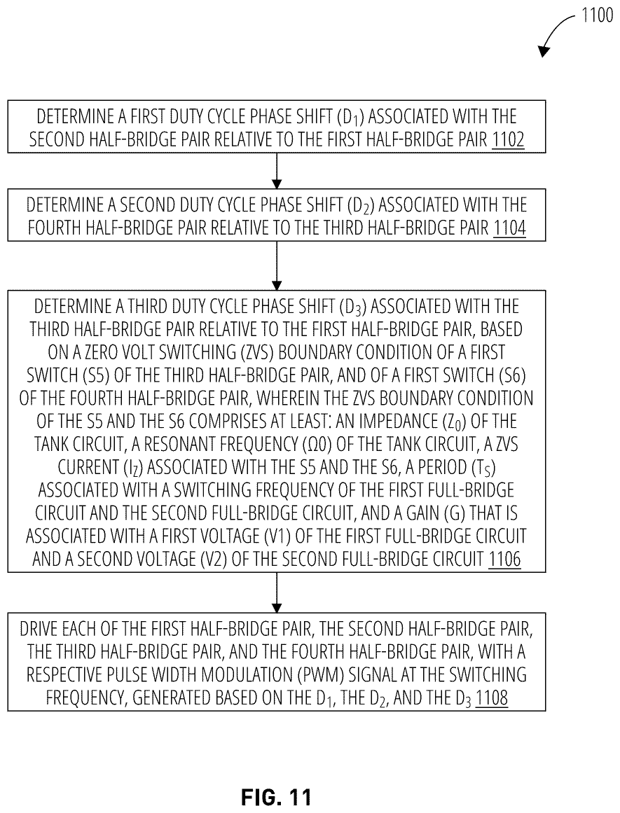

FIG. 11 shows a flow diagram of a method 1100 for operating a bidirectional converter, according to some embodiments. The method 1100 may be performed by processing logic that may comprise hardware (circuitry, dedicated logic, etc.), software (such as is run on a general purpose computer system or a dedicated machine), firmware, or a combination. The method 1100 may be performed by one or more vehicle controllers such as those mentioned in other sections. In an example, each of the blocks performed by processing logic are performed automatically, without human input.

The method 1100 may be operative by processing logic to control bidirectional converter 100 comprising a first full-bridge circuit comprising a first half-bridge pair of switches and a second half-bridge pair of switches, a second full-bridge circuit comprising a third half-bridge pair of switches and fourth half-bridge pair of switches, and a resonant circuit comprising a first inductor connected in series with a first capacitor. The resonant circuit electrically couples the first full-bridge circuit and the second full-bridge circuit. The bidirectional converter 100 may comprise different circuit implementations, such as those described, for example, with respect to FIG. 1, or FIG. 3. Aspects described with respect to method 1100 may correspond to operations performed by a controller, as described in other sections.

At block 1102, method 1100 determines a first duty cycle phase shift (d₁) associated with the second half-bridge pair relative to the first half-bridge pair. At block 1104, method 1100 determines a second duty cycle phase shift (d₂) associated with the fourth half-bridge pair relative to the third half-bridge pair.

The method may determine phase shift d₂ as zero, to solve for d₁ and/or d₃. The determination of phase shift d1 may vary depending on whether method 1100 is operating the bidirectional converter on the ZVS boundary condition of point 1 or point 2.

At block 1106, method 1100 determines a third duty cycle phase shift (d₃) associated with the third half-bridge pair relative to the first half-bridge pair, based on a zero volt switching (ZVS) boundary condition of a first switch (S5) of the third half-bridge pair, and of a first switch (S6) of the fourth half-bridge pair, wherein the ZVS boundary condition of the S5 and the S6 comprises at least: an impedance (Z₀) of the resonant circuit, a resonant frequency (ω₀) of the resonant circuit, a ZVS current (I₂) associated with the S5 and the S6, a period (Tₛ) associated with a switching frequency of the first full-bridge circuit and the second full-bridge circuit, and a gain (G) that is associated with a first voltage (v1) of the first full-bridge circuit and a second voltage (v2) of the second full-bridge circuit.

In the case of point 1 operation, the method may set d₁ to zero, and set d₂ to zero. With d₁ and d₂ set to zero, the parameters for d₃ can be determined in a straightforward manner, such as being determined based on a single equation. In some embodiments, in response to G being above a threshold, the method inverts the gain G (e.g., 1/G) and uses the inverted value to calculate d₃, as shown below.

In some embodiments, in response an instantaneous power and the gain G exceeding a boundary of the switching frequency at a maximum load of the bidirectional converter, the controller fixes the switching frequency to a constant value. This may be referred to as PSM, as described in other sections. The controller continues to control the bidirectional inverter by adjusting the phase shift d₃.

In some embodiments, d₃ is determined based on a modeled expression comprising:

$${d}_{3} = 0.25 - \frac{{sin}^{- 1} ( - \frac{{I}_{z} {Z}_{0}}{{v}_{1}} cos ( \frac{{ω}_{0} {T}_{S}}{4} ) + G sin ( \frac{{ω}_{0} {T}_{S}}{4} ) )}{{ω}_{0} {T}_{S}}$$

when G is less than 1, and

$${d}_{3} = 0.25 - \frac{{sin}^{- 1} ( - \frac{{I}_{z} {Z}_{0}}{{v}_{1}} cos ( \frac{{ω}_{0} {T}_{S}}{4} ) + \frac{1}{G} sin ( \frac{{ω}_{0} {T}_{S}}{4} ) )}{{ω}_{0} {T}_{S}}$$

when G is greater than or equal to 1.

As shown in the above model, when G is greater than a threshold, the method may invert G to 1/G while leaving all other parameters the same as when G is not greater than the threshold.

In the case of point 2 operation, determining the phase shift d₂ comprises setting d₂ at zero. With d₂ at zero, the controller determines the d₁ and the d₃ are based on the ZVS boundary condition of the S5 and the S6 and further based on a ZVS boundary condition of a first switch (S2) of the second half-bridge pair. The ZVS boundary condition of the S2 comprises at least: the Z₀, the ω₀, an I_{z} associated with the S2, and the Tₛ.

In some embodiments, d₁, d₃, and a target power P₀ are determined based on at least on the G, the Tₛ, the ω₀, and/or I_{z}. In some embodiments, the d₁ and the d₃ are determined based on the following model:

$$- {I}_{Z} = - \frac{{v}_{1} ( sin ( {w}_{0} {T}_{S} ( 0.25 - {d}_{1} ) ) + sin ( \frac{{w}_{0} {T}_{S}}{4} ) - 2 G sin ( {w}_{0} {T}_{S} ( \frac{1}{4} + {d}_{1} - {d}_{3} ) ) )}{2 {Z}_{0} cos ( \frac{{w}_{0} {T}_{S}}{4} )} ,$$

$${I}_{Z} = - \frac{{v}_{1} ( sin ( {w}_{0} {T}_{S} ( 0.25 - {d}_{1} ) ) + sin ( {w}_{0} {T}_{S} ( 0.25 - {d}_{3} + {d}_{1} ) ) - 2 G sin ( \frac{{w}_{0} {T}_{S}}{4} ) )}{2 {Z}_{0} cos ( \frac{{w}_{0} {T}_{S}}{4} )} , and$$

$${P}_{o} = \frac{2 {Gv}_{1}^{2}}{{w}_{0} {T}_{S} {Z}_{0}} ( \frac{( cos ( \frac{{w}_{0} {T}_{S}}{4} ( 4 {d}_{1} - 4 {d}_{3} + 1 ) ) + cos ( \frac{{w}_{0} {T}_{S}}{4} ( 4 {d}_{3} - 1 ) ) )}{cos ( \frac{{w}_{0} {T}_{S}}{4} )} - 2 ) .$$

Due to the complexity of the model, the method may determine d₁ and d₃ for point 2 operation, based on a lookup table which outputs d₁, d₃, and P₀ based on input parameters such as gain G, the switching period Tₛ, ω₀, the I_{z}, and a target power PG.

More generally, the method 1100 may calculate d1 and/or d3 while setting d₂ at zero, and solving for d1 and/or d3 based on ZVS boundary condition 404, ZVS boundary condition 406, and ZVS boundary condition 408. The phase shifts d1 and/or d3 can be determined based on models by direct calculation, or by implementing a lookup algorithm. Switching period Ts may vary based on the target current or power, or be fixed in some cases, as described.

At block 1108, method 1100 drives each of the first half-bridge pair, the second half-bridge pair, the third half-bridge pair, and the fourth half-bridge pair, with a respective pulse width modulation (PWM) signal at the switching frequency, generated based on the phase shifts d₁, d₂, and d₃. Method 1100 may modulate the switching frequency or period Ts based on the desired output current and power. For example, an increased in targeted current or power may result in an increase in switching frequency, and vice versa.

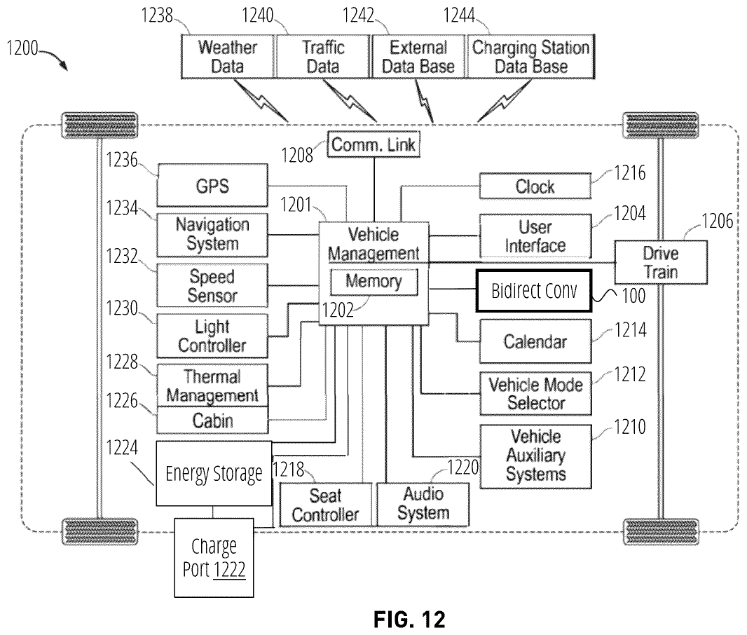

FIG. 12 is a high-level view of some embodiments of a vehicle 1200, in accordance with an embodiment. Vehicle 1200 can be an electric vehicle (EV), a vehicle utilizing an internal combustion engine (ICE), or a hybrid vehicle, where a hybrid vehicle utilizes multiple sources of propulsion including an electric drive system. Vehicle 1200 includes a vehicle on-board system controller 1201, also referred to herein as a vehicle management system, which is comprised of one or more processors (e.g., a central processing unit (CPU)). System controller 1201 also includes memory 1202, with memory 1202 being comprised of EPROM, EEPROM, flash memory, RAM, solid state drive, hard disk drive, or any other type of memory or combination of memory types.

In some embodiments, vehicle 1200 includes one or more internal networks by which system controller 1201 interfaces and communicates with one or more internal subsystems of vehicle 1200. System controller 1201 can also use the one or more internal networks to transfer communications to and from external locations. In some embodiments, the one or more internal networks can be communicably coupled to one or more networks through a network interface. The network interface can provide for wired and/or wireless communication. When used in a local area networking environment (or a wide area networking environment), the network interface can include an Ethernet interface and the one or more internal networks includes an Ethernet communication network (e.g., an Ethernet Ring, etc.) with an Ethernet Port. Other possible embodiments use other communication devices. For example, in some embodiments vehicle 1200 includes a modem for communicating across an internal network and/or with an external network.

In some embodiments, vehicle 1200 includes a charge port 1222 and one or more batteries (e.g., battery pack, etc.), and a battery charger, as an energy storage system 1224 that provides power to portions of vehicle 1200. The charge port 1222 is used for providing voltage to vehicle 1200 for charging the energy storage system 1224 (e.g., charging batteries by the use of, for example, an EVSE or other power source in a manner well-known in the art. The charging port 1222 can be used to transfer power from a battery of the energy storage system 1224 to an external location as part of a vehicle-to-grid power transfer. In some embodiments, charging port 1222 includes a communication path for communications between the system controller 1201 and the locations external to vehicle 1200 such as, for example, the power source providing power (voltage) to vehicle 1200 for charging batteries of the energy storage system 1224 and a utility distributed energy resource management system (DERMS) or an electric utility company and its facilities.

In some embodiments, energy storage system 1224 includes an inverter that generates voltage for transfer to an electric power grid. In some embodiments, the inverter converts DC voltage to AC voltage for transfer to the electric power grid. In some embodiments, the same inverter (or a separate invertor) converts DC voltage to AC voltage for charging a battery of the energy storage system 1224 or can provide DC to AC voltage conversion when providing power to an electrical power grid as part of a vehicle-to-grid operation. In the case of DC fast charging, the inverter may be bypassed to charge the battery pack directly with DC voltage from a charger that is connected to 1222.

In some embodiments, vehicle 1200 includes a user interface 1204 is coupled to vehicle management system 1201. Interface 1204 allows the driver, or a passenger, to interact with the vehicle management system, for example inputting data into the navigation system 1234, altering the heating, ventilation and air conditioning (HVAC) system via the thermal management system 1226, controlling the vehicle's entertainment system (e.g., radio, CD/DVD player, etc.), adjusting vehicle settings (e.g., seat positions, light controls, etc.), and/or otherwise altering the functionality of vehicle 1200. In some embodiments, user interface 1204 also includes means for the vehicle management system to provide information to the driver and/or passenger, information such as a navigation map or driving instructions (e.g., via the navigation system 1234 and GPS system 1236) as well as the operating performance of any of a variety of vehicle systems (e.g., battery pack charge level for an EV, fuel level for an ICE-based or hybrid vehicle, selected gear, current entertainment system settings such as volume level and selected track information, external light settings, current vehicle speed (e.g., via speed sensor 1232), current HVAC settings such as cabin temperature and/or fan settings, etc.) via the thermal management system 1226. Interface 405 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). Vehicle 1200 can also include other features like an internal clock 1216 and a calendar 1214.

In some embodiments, user interface 1204 includes one or more interfaces including, for example, a front dashboard display (e.g., a cockpit display, etc.), a touch-screen display (e.g., a pilot panel, etc.), as well as a combination of various other user interfaces such as push-button switches, capacitive controls, capacitive switches, slide or toggle switches, gauges, display screens, warning lights, audible warning signals, etc. It should be appreciated that if user interface 1204 includes a graphical display, controller 1201 may also include a graphical processing unit (GPU), with the GPU being either separate from or contained on the same chip set as the processor. User interface 1204 may be referred to as a human machine interface (HMI).

Vehicle 1200 also includes a drive train 1206 that can include an internal combustion engine, one or more motors, or a combination of both. The vehicle's drive system can be mechanically coupled to the front axle/wheels, the rear axle/wheels, or both, and may utilize any of a variety of transmission types (e.g., single speed, multi-speed) and differential types (e.g., open, locked, limited slip). Drive train 1206 may also comprise one or more drive units each comprising a drive circuit and respective motor.

Drivers often alter various vehicle settings, either when they first enter the car or while driving, in order to vary the car to match their physical characteristics, their driving style and/or their environmental preferences. System controller 1201 monitors various vehicle functions that the driver may use to enhance the fit of the car to their own physical characteristics, such as seat position (e.g., seat position, seat height, seatback incline, lumbar support, seat cushion angle and seat cushion length) using seat controller 1218 and steering wheel position using an auxiliary vehicle system controller 1210. In some embodiments, system controller 1201 also can monitor a driving mode selector 1212 which is used to control performance characteristics of the vehicle (e.g., economy, sport, normal). In some embodiments, system controller 1201 can also monitor suspension characteristics using auxiliary vehicle system 1210, assuming that the suspension is user adjustable. In some embodiments, system controller 1201 also monitors those aspects of the vehicle which are often varied by the user in order to match his or her environmental preferences for the cabin 1226, for example setting the thermostat temperature or the recirculation controls of the thermal management system 1226 that uses an HVAC controller, and/or setting the radio station/volume level of the audio system using controller 1220, and/or setting the lights, either internal lighting or external lighting, using light controller 1230. Also, besides using user-input and on-board sensors, system controller 1201 can also use data received from an external on-line source that is coupled to the controller via communication link 1208 (using, for example, GSM, EDGE, UMTS, CDMA, DECT, Wi-Fi, WiMAX, etc.). For example, in some embodiments, system controller 1201 can receive weather information using an on-line weather service 1238 or an on-line data base 1242, traffic data 1240 for traffic conditions for the navigation system 1234, charging station locations from a charging station database 1244, etc. In some embodiments, communication link 1208 comprises an Ethernet communication link with an Ethernet Port for external communications.

The system controller 1201 can transfer information with the components described above over one or more internal networks, such as those, for example, described above. In some embodiments, the system controller 1201 is communicably coupled to one or more of these components via an Ethernet communication network (e.g., an Ethernet Ring, etc.). The Ethernet communication network can be used to transfer other data such as data related to, but not limited to, one or more of a driver-assistance system, telematics, over-the-air updates, etc.

The vehicle may comprise a thermal management system 1228 which may include one or more temperature sensors, one or more cooling systems (e.g., liquid lines, coolant, pump, fan, heatsink, heat pipe, cooler, evaporator, refrigeration, etc.).

The vehicle may comprise a bidirectional converter 100. The bidirectional converter includes a first full-bridge circuit comprising a first half-bridge pair of switches and a second half-bridge pair of switches, a second full-bridge circuit comprising a third half-bridge pair of switches and fourth half-bridge pair of switches, and a resonant circuit comprising a first inductor connected in series with a first capacitor. The resonant circuit electrically couples the first full-bridge circuit and the second full-bridge circuit. The bidirectional converter 100 further comprises a controller, configured to determine a first duty cycle phase shift (d₁) associated with the second half-bridge pair relative to the first half-bridge pair, determine a second duty cycle phase shift (d₂) associated with the fourth half-bridge pair relative to the third half-bridge pair, and determining a third duty cycle phase shift (d₃) associated with the third half-bridge pair relative to the first half-bridge pair. The controller determines the third duty cycle phase shift (d3) based on a zero volt switching (ZVS) boundary condition of a first switch (S5) of the third half-bridge pair, and of a first switch (S6) of the fourth half-bridge pair, wherein the ZVS boundary condition of the S5 and the S6 comprises at least: an impedance (Z₀) of the resonant circuit, a resonant frequency (ω₀) of the resonant circuit, a ZVS current (I_{z}) associated with the S5 and the S6, a period (Tₛ) associated with a switching frequency of the first full-bridge circuit and the second full-bridge circuit, and a gain (G) that is associated with a first voltage (v1) of the first full-bridge circuit and a second voltage (v2) of the second full-bridge circuit. The controller drives each of the first half-bridge pair, the second half-bridge pair, the third half-bridge pair, and the fourth half-bridge pair, with a corresponding pulse width modulation (PWM) signal at the switching frequency, generated based on the d₁, the d₂, and the d₃. The controller may determine d3 as described, to maintain the ZVS boundary condition 404, or the ZVS boundary condition 406, or the ZVS boundary condition 408, as described. Bidirectional converter 100 may be coupled between and operative to direct current between energy storage 1224 and charge port 1222.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A bidirectional converter, comprising:
a first full-bridge circuit comprising a first half-bridge pair of switches and a second half-bridge pair of switches;
a second full-bridge circuit comprising a third half-bridge pair of switches and fourth half-bridge pair of switches;
a resonant circuit comprising a first inductor connected in series with a first capacitor, wherein the resonant circuit electrically couples the first full-bridge circuit and the second full-bridge circuit; and
a controller, configured to perform operations comprising:
determining a first duty cycle phase shift (d₁) associated with the second half-bridge pair relative to the first half-bridge pair;
determining a second duty cycle phase shift (d₂) associated with the fourth half-bridge pair relative to the third half-bridge pair;
determining a third duty cycle phase shift (d₃) associated with the third half-bridge pair relative to the first half-bridge pair, based on a zero volt switching (ZVS) boundary condition of a first switch (S5) of the third half-bridge pair, and of a first switch (S6) of the fourth half-bridge pair, wherein the ZVS boundary condition of the S5 and the S6 comprises at least: an impedance (Z₀) of the resonant circuit, a resonant frequency (ω₀) of the resonant circuit, a ZVS current (I_{z}) associated with the S5 and the S6, a period (Tₛ) associated with a switching frequency of the first full-bridge circuit and the second full-bridge circuit, and a gain (G) that is associated with a first voltage (v1) of the first full-bridge circuit and a second voltage (v2) of the second full-bridge circuit; and
driving each of the first half-bridge pair, the second half-bridge pair, the third half-bridge pair, and the fourth half-bridge pair, with a corresponding pulse width modulation (PWM) signal at the switching frequency, generated based on the d₁, the d₂, and the d₃.

2. The bidirectional converter of claim 1, wherein determining the d₁ comprises setting d₁ to zero, and wherein determining the d₂ comprises setting d₂ to zero.

3. The bidirectional converter of claim 2, wherein determining the d₃ based on the ZVS boundary condition of the S5 and the S6 comprises inverting the G, in response to the G being above a threshold.

4. The bidirectional converter of claim 2, wherein the operations further comprise, in response an instantaneous power and the G exceeding a boundary of the switching frequency at a maximum load of the bidirectional converter, fixing the switching frequency to a constant value.

5. The bi-directional converter of claim 2, wherein d₃ is determined based on an expression comprising:
$${d}_{3} = 0.25 - \frac{{sin}^{- 1} ( - \frac{{I}_{z} {Z}_{0}}{{v}_{1}} cos ( \frac{{ω}_{0} {T}_{S}}{4} ) + G sin ( \frac{{ω}_{0} {T}_{S}}{4} ) )}{{ω}_{0} {T}_{S}}$$
when G<1, and
$${d}_{3} = 0.25 - \frac{{sin}^{- 1} ( - \frac{{I}_{z} {Z}_{0}}{{v}_{1}} cos ( \frac{{ω}_{0} {T}_{S}}{4} ) + \frac{1}{G} sin ( \frac{{ω}_{0} {T}_{S}}{4} ) )}{{ω}_{0} {T}_{S}}$$
when G> or =1.

6. The bidirectional converter of claim 1, wherein determining the d₂ comprises setting the d₂ at zero, and wherein the d₁ and the d₃ are determined based on the ZVS boundary condition of the S5 and the S6 and further based on a ZVS boundary condition of a first switch (S2) of the second half-bridge pair, wherein the ZVS boundary condition of the S2 comprises at least: the Z₀, the ω₀, an I_{z} associated with the S2, and the Tₛ.

7. The bidirectional converter of claim 6, wherein the d₁ and the d₃ are determined based on the following:
$$- {I}_{Z} = - \frac{{v}_{1} ( sin ( {w}_{0} {T}_{S} ( 0.25 - {d}_{1} ) ) + sin ( \frac{{w}_{0} {T}_{S}}{4} ) - 2 G sin ( {w}_{0} {T}_{S} ( \frac{1}{4} + {d}_{1} - {d}_{3} ) ) )}{2 {Z}_{0} cos ( \frac{{w}_{0} {T}_{S}}{4} )} ,$$
$${I}_{Z} = - \frac{{v}_{1} ( sin ( {w}_{0} {T}_{S} ( 0.25 - {d}_{1} ) ) + sin ( {w}_{0} {T}_{S} ( 0.25 - {d}_{3} + {d}_{1} ) ) - 2 G sin ( \frac{{w}_{0} {T}_{S}}{4} ) )}{2 {Z}_{0} cos ( \frac{{w}_{0} {T}_{S}}{4} )} , and$$
$${P}_{o} = \frac{2 {Gv}_{1}^{2}}{{w}_{0} {T}_{S} {Z}_{0}} ( \frac{( cos ( \frac{{w}_{0} {T}_{S}}{4} ( 4 {d}_{1} - 4 {d}_{3} + 1 ) ) + cos ( \frac{{w}_{0} {T}_{S}}{4} ( 4 {d}_{3} - 1 ) ) )}{cos ( \frac{{w}_{0} {T}_{S}}{4} )} - 2 ) .$$

8. The bidirectional converter of claim 7, wherein the d₁, the d₃, and a target power P₀ are determined based on a lookup table, based on at least on the G, the Tₛ, the ω₀, the I_{z}.

9. The bidirectional converter of claim 1, wherein the first full-bridge circuit is coupled to an unfolding bridge circuit operating at 60 Hz.

10. The bidirectional converter of claim 1, wherein each switch of the first half-bridge pair and the second half-bridge pair comprises two power switching devices coupled in series and wherein the first full-bridge circuit is coupled to an alternating current (AC) voltage.

11. The bidirectional converter of claim 1, wherein the bi-directional converter is integral to an electric vehicle, wherein the second full-bridge circuit is coupled to a battery of the electric vehicle, and the first full-bridge circuit is coupled to a vehicle port for receiving power from an external power source.

12. The bidirectional converter of claim 1, wherein the resonant circuit comprises a second inductor coupled in series to a second capacitor, and a transformer that couples the first inductor and the first capacitor to the second inductor and the second capacitor.

13. An electric vehicle comprising a bidirectional converter, the bidirectional converter comprising:
a first full-bridge circuit comprising a first half-bridge pair of switches and a second half-bridge pair of switches;
a second full-bridge circuit comprising a third half-bridge pair of switches and fourth half-bridge pair of switches;
a resonant circuit comprising a first inductor connected in series with a first capacitor, wherein the resonant circuit electrically couples the first full-bridge circuit and the second full-bridge circuit; and
a controller, configured to perform operations comprising:
determining a first duty cycle phase shift (d₁) associated with the second half-bridge pair relative to the first half-bridge pair;
determining a second duty cycle phase shift (d₂) associated with the fourth half-bridge pair relative to the third half-bridge pair;
determining a third duty cycle phase shift (d₃) associated with the third half-bridge pair relative to the first half-bridge pair, based on a zero volt switching (ZVS) boundary condition of a first switch (S5) of the third half-bridge pair, and of a first switch (S6) of the fourth half-bridge pair, wherein the ZVS boundary condition of the S5 and the S6 comprises at least: an impedance (Z₀) of the resonant circuit, a resonant frequency (ω₀) of the resonant circuit, a ZVS current (I_{z}) associated with the S5 and the S6, a period (Tₛ) associated with a switching frequency of the first full-bridge circuit and the second full-bridge circuit, and a gain (G) that is associated with a first voltage (v1) of the first full-bridge circuit and a second voltage (v2) of the second full-bridge circuit; and
driving each of the first half-bridge pair, the second half-bridge pair, the third half-bridge pair, and the fourth half-bridge pair, with a corresponding pulse width modulation (PWM) signal at the switching frequency, generated based on the d₁, the d₂, and the d₃.

14. The electric vehicle of claim 13, wherein determining the d₁ comprises setting d₁ to zero, and wherein determining the d₂ comprises setting d₂ to zero.

15. The electric vehicle of claim 14, wherein determining the d₃ based on the ZVS boundary condition of the S5 and the S6 comprises inverting the G, in response to the G being above a threshold.

16. The electric vehicle of claim 14, wherein in response an instantaneous power and the G exceeding a boundary of the switching frequency at a maximum load of the bidirectional converter, fixing the switching frequency to a constant value.

17. The electric vehicle of claim 14, wherein d₃ is determined based on an expression comprising:
$${d}_{3} = 0.25 - \frac{{sin}^{- 1} ( - \frac{{I}_{z} {Z}_{0}}{{v}_{1}} cos ( \frac{{ω}_{0} {T}_{S}}{4} ) + G sin ( \frac{{ω}_{0} {T}_{S}}{4} ) )}{{ω}_{0} {T}_{S}}$$
when G<1, and
$${d}_{3} = 0.25 - \frac{{sin}^{- 1} ( - \frac{{I}_{z} {Z}_{0}}{{v}_{1}} cos ( \frac{{ω}_{0} {T}_{S}}{4} ) + \frac{1}{G} sin ( \frac{{ω}_{0} {T}_{S}}{4} ) )}{{ω}_{0} {T}_{S}}$$
when G> or =1.

18. A method performed by a controller to operate a bidirectional converter comprising: a first full-bridge circuit comprising a first half-bridge pair of switches and a second half-bridge pair of switches, a second full-bridge circuit comprising a third half-bridge pair of switches and fourth half-bridge pair of switches, a resonant circuit comprising a first inductor connected in series with a first capacitor, wherein the resonant circuit electrically couples the first full-bridge circuit and the second full-bridge circuit, and the method comprising:
determining a first duty cycle phase shift (d₁) associated with the second half-bridge pair relative to the first half-bridge pair;
determining a second duty cycle phase shift (d₂) associated with the fourth half-bridge pair relative to the third half-bridge pair;
determining a third duty cycle phase shift (d₃) associated with the third half-bridge pair relative to the first half-bridge pair, based on a zero volt switching (ZVS) boundary condition of a first switch (S5) of the third half-bridge pair, and of a first switch (S6) of the fourth half-bridge pair, wherein the ZVS boundary condition of the S5 and the S6 comprises at least: an impedance (Z₀) of the resonant circuit, a resonant frequency (ω₀) of the resonant circuit, a ZVS current (I_{z}) associated with the S5 and the S6, a period (Tₛ) associated with a switching frequency of the first full-bridge circuit and the second full-bridge circuit, and a gain (G) that is associated with a first voltage (v1) of the first full-bridge circuit and a second voltage (v2) of the second full-bridge circuit; and
driving each of the first half-bridge pair, the second half-bridge pair, the third half-bridge pair, and the fourth half-bridge pair, with a respective pulse width modulation (PWM) signal at the switching frequency, generated based on the d₁, the d₂, and the d₃.

19. The method of claim 18, wherein determining the d₁ comprises setting d₁ to zero, and wherein determining the d₂ comprises setting d₂ to zero.

20. The method of claim 19, wherein determining the d₃ based on the ZVS boundary condition of the S5 and the S6 comprises inverting the G, in response to the G being above a threshold.
